(19) United States
(12) Patent Application Publication
(10) Pub. No.: US 2014/0092109 A1
(43) Pub. Date: Apr. 3, 2014

(54) COMPUTER SYSTEM AND METHOD FOR GPU DRIVER-GENERATED INTERPOLATED FRAMES

(71) Applicant: NVIDIA CORPORATION, Santa Clara, CA (US)

(72) Inventor: Scott Saulters, Xi Zhi District (TW)

(73) Assignee: NVIDIA CORPORATION, Santa Clara, CA (US)

(21) Appl. No.: 13/730,473

(22) Filed: Dec. 28, 2012

(30) Foreign Application Priority Data
Sep. 28, 2012 (TW) 101136129

(51) Int. Cl. G06T 1/20

(52) U.S. Cl. CPC G06T 1/20
USPC 345/522

(57) ABSTRACT

The invention provides a method for driving a graphic processing unit (GPU). The method comprises the steps of: (a) receiving a plurality of requests for processing a first frame, a second frame and a third frame; (b) sequentially rendering the first frame and the third frame; (c) performing an interpolation to generate the second frame according to the rendered first frame and the rendered third frame; and, (d) sequentially displaying the rendered first frame, the second frame generated by interpolation and the rendered third frame.

### CROSS-REFERENCE TO RELATED APPLICATIONS

This application is based on and claims the benefit of priority from Taiwan Patent Application 101136129, filed on Sep. 28, 2012, which is hereby incorporated herein by reference.

### BACKGROUND OF THE INVENTION

1. Field of the Invention

The present invention relates to a method for driving a graphic processing unit (GPU).

2. Description of the Related Art

When a graphic processing unit is rendering a frame, it needs to process a lot of information, for example, including the geometry information, the viewpoint information, the texture information, the lighting information and the shading information, or a combination of the information listed above. Furthermore, during processing different information, the processing time and power consumption required by the graphic processing unit are different. For example, the time and power consumption required for processing of lighting and shading information will be more.

In order to save the processing time and power consumption, in the prior art, an application program, such as a game program, is programmed to have the information of the previous frame reused while rendering frames. For example, for rendering a first frame and a second frame for display, only the lighting information (may be other information) of the first frame is rendered, and the lighting information of the second frame repetitively employs the lighting information of the first frame, such that the processing time and power consumption for rendering the lighting information of the second frame may be saved.

### SUMMARY OF THE INVENTION

One aspect of the present invention provides a method for driving a graphic processing unit. In an embodiment, the method can provide the information with higher accuracy compared to the conventional method. Particularly, the method is implemented by a driver program of the graphic processing unit and is not handled at the application program level, so that the method could be used irrespective of the application program(s).

Another aspect of the present invention provides a method for driving a graphic processing unit using interpolation. The interpolation is used to generate a specific ratio of frames from all the frames because of the adjacent frames having higher correlation. For example, each of the plurality of displayed frames may have one of them being the frame generated by interpolation. Compared to the rendered frame, the frame generated by interpolation may save the processing time and power consumption of the graphic processing unit.

One embodiment according to the present invention provides a method for driving a graphic processing unit, which includes the following steps:

receiving a request for processing a N^{th} frame, a (N+A)^{th} frame, and a (N+A+B)^{th} frame sent by an application program, in which N, A and B are respectively positive integers;

controlling the graphic processing unit to sequentially render the N^{th} frame and the (N+A+B)^{th} frame according to the request for processing the N^{th} frame and the (N+A+B)^{th} frame;

controlling the graphic processing unit to perform an interpolation for generating the (N+A)^{th} frame according to the N^{th} frame and the (N+A+B)^{th} frame; and

controlling the graphic processing unit to sequentially display the rendered N^{th} frame, the (N+A)^{th} frame generated by interpolation, and the rendered (N+A+B)^{th} frame.

An embodiment according to the present invention provides a frame display method for a graphic processing unit, which includes:

sequentially rendering a N^{th} frame and a (N+A+B)^{th} frame, in which N, A and B are respectively positive integers;

performing an interpolation for generating a (N+A)^{th} frame according to the rendered N^{th} frame and the rendered (N+A+B)^{th} frame; and

sequentially displaying the rendered N^{th} frame, the (N+A)^{th} frame generated by interpolation, and the rendered (N+A+B)^{th} frame.

An embodiment according to the present invention provides a computer system, which comprises:

a graphic processing unit; and

a central processing unit, which is electrically connected with the graphic processing unit to execute the method for driving the graphic processing unit.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a computer system of an embodiment according to the present invention;

FIG. 2 illustrates a method for driving a graphic processing unit of an embodiment according to the present invention;

FIG. 3 illustrates a method for driving a graphic processing unit of another embodiment according to the present invention; and

FIG. 4 illustrates a method for driving a graphic processing unit of another embodiment according to the present invention.

### DETAILED DESCRIPTION

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

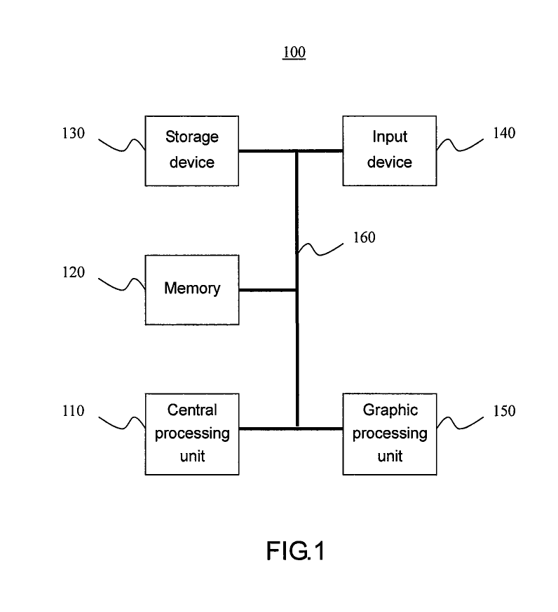

Referring now to FIG. 1 through FIG. 4, computer system, methods, and computer program products are illustrated as structural or functional block diagrams or process flowcharts according to various embodiments of the present invention. The flowchart and block diagrams in the Figures illustrate the architecture, functionality, and operation of possible implementations of computer system, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### System Architecture

It is understood that embodiments can be practiced on many different types of computer system 100. Examples include, but are not limited to, desktop computers, workstations, servers, media servers, laptops, gaming consoles, digital televisions, PVRs, and personal digital assistants (PDAs), as well as other electronic devices with computing and data storage capabilities, such as wireless telephones, media center computers, digital video recorders, digital cameras, and digital audio playback or recording devices.

FIG. 1 illustrates a computer system 100 of an embodiment according to the present invention. The computer system 100 comprises a central processing unit 110, a memory 120, a storage device 130, an input device 140, a graphic processing unit 150 and a communication bus 160. FIG. 1 ignores the components somewhat irrelevant to the present invention. In the computer system 100 of FIG. 1, the central processing unit 110, the memory 120, the storage device 130, the input device 140 and the graphic processing unit 150 are connected with each other through the communication bus 160.

The central processing unit 110 is configured to process the data and instructions. The memory 120 and the storage device 130 are configured to store the data and instructions, such as computer-readable program codes, data structure and program module; and, the memory 120 and the storage device 130 may be volatile or non-volatile, removable or non-removable computer-readable medium. The input device 140 is configured to input the data and instructions. The graphic processing unit 150 is configured to process the data and instructions from the central processing unit 110 and associated with the processing of graphics, images or videos, such as for rendering a frame. The communication bus 160 is configured for the communication of data or instructions.

In an embodiment according to the present invention, the central processing unit 110 and the graphic processing unit 150 process the data and instructions associated with the present invention, such as data and instructions associated with the method for driving the graphic processing unit according to the present invention. The data and instructions associated with the present invention, such as computer-readable program codes, may be stored in the computer-readable medium, such as the memory 120 and the storage device 130.

### First Embodiment

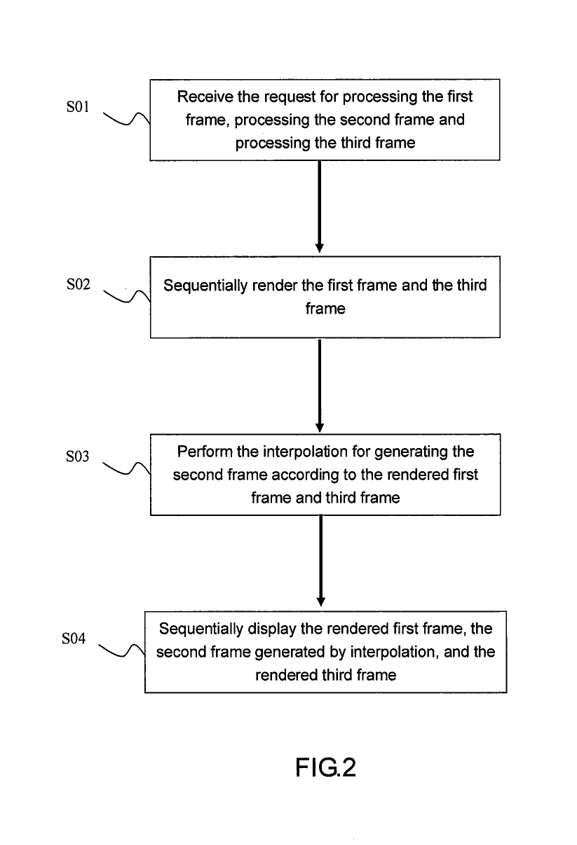

FIG. 2 illustrates a method for driving a graphic processing unit 150 of an embodiment according to the present invention. The method may be applied to the computer system 100 as shown in FIG. 1. In particular, the method may be executed by the central processing unit 110 running a GPU driver program in cooperation with the graphic processing unit 150. In short, the method shown in FIG. 2 may employ two rendered frames for interpolation to generate a frame, and the display sequence of the frame generated by interpolation is between the displaying of the two rendered frames as further described below.

The following description should be referred in connection with FIG. 1 and FIG. 2.

Step S01: In order to sequentially display the first frame, the second frame and the third frame, the application program sent the request for processing the first, second and third frames, and the central processing unit 110 receives the request for processing the first, second and third frames. The application program may be a game program, a graphic processing program, or other application programs associated with the graphics.

Step S02: The graphic processing unit 150 sequentially renders the first frame and the third frame. The central processing unit 110 controls the graphic processing unit 150 to firstly render the first frame, and then render the third frame according to the request for processing the first frame and processing the third frame. The information required for rendering a frame includes: the geometry information, the viewpoint information, the texture information, the lighting information, the shading information, or a combination of the information listed above.

In response to the request for processing the first, second and third frames in Step S02, the graphic processing unit 150 is controlled to only render the first and third frames, but ignore the rendering of the second frame. The following context will further describe the method for generating the second frame. Because the frame rendering by the graphic processing unit 150 will consume more processing time and power, the present embodiment employs another alternative method to generate the second frame to achieve the effects of saving processing time and power.

Moreover, Step S02 may further employ the central processing unit 110 or the graphic processing unit 150 to measure the time required for frame rendering, such as measuring the time required for rendering the first frame as duration V1, measuring the time required for rendering the third frame as a duration V3. The durations V1, V3 are further described in the following context.

Step S03: The central processing unit 110 controls the graphic processing unit 150 to perform the interpolation to generate the second frame according to the rendered first and third frames. For example, the interpolation may be a linear interpolation or a non-linear interpolation.

Making an example of lighting information, the graphic processing unit 150 may perform the interpolation to generate the lighting information of the second frame according to the light information of the rendered first frame and the lighting information of the rendered third frames. It should be noted that the present embodiment may also perform the interpolation to generate other information, such as geometry information, viewpoint information, texture information, shading information, or combination of information listed above.

Similarly, Step S03 may further employs the central processing unit 110 or the graphic processing unit 150 to measure the time required for interpolation of the second frame, such as measuring the time required for interpolation of the second frame as a duration V2. The duration V2 is further described in the following context.

Step S04: The method sequentially displays the rendered first frame, the second frame generated by interpolation, and the rendered third frame. The central processing unit 110 controls the graphic processing unit 150 to sequentially display the rendered first frame, the second frame generated by interpolation, and the rendered third frame. Preferably, the rendered first frame is displayed right after the third frame is rendered. It should be noted that the first, second and third frames are configured by the application program to be sequential.

Because the first frame, the second frame and the third frame are configured to be sequentially displayed, the present embodiment employs the two frames adjacent to the second frame, i.e. the first and third frames, having high correlation with the second frame to make the second frame generated by interpolation to have higher accuracy. Herein, the higher accuracy means that the probability of error generation between the second frame generated by interpolation and the rendered second frame may be smaller.

The present embodiment does not actually render the second frame. Generally, the second frame generated by interpolation may require less time than rendering of the second frame, so that it may usually save the processing time and power for the graphic processing unit 150.

Furthermore, the total time for processing the frame (rendered frame or interpolated frame) is approximately equal for consecutive frames. Thus, the present embodiment may artificially delay the second frame after generation of the second frame, so as to avoid inconsistent frame rates which will cause the micro stuttering perceived by a user while viewing the first, second and third frames, for example feeling slight frame stagnation. In the present embodiment, the effect of delaying the second frame may be achieved by sleeping the calling thread of an application program (such as a game program). As the thread is slept, the power to some but not all components of the graphic processing unit 150 is turned off, i.e., the graphic processing unit 150 is power-gated. Hence, the second frame is delayed because the graphic processing unit 150 is not working as the thread is slept. Please make reference to US Pub. 2012/0146706 for more details about engine level power gating (ELPG).

For example, if the duration for processing consecutive frames is around 5 ms and the duration V1 for rendering the first frame is 5 ms. Similarly, the duration V3 for rendering the third frame is also 5 ms. In comparison, the duration V2 for generating the second frame by interpolation may be shorter than 3 ms. Therefore the frame rates become inconsistent and the user may possibly perceive the micro stuttering if the second frame was not delayed. Therefore, after generation of the second frame, the time difference between any one of the duration V1 or the duration V3 and the duration V2, i.e. V1−V2 or V3−V2, may be referred to sleep the thread and accordingly power-gate the graphic processing unit 150 for the second frame, such that the frame rates become less inconsistent. For example, the duration V2 for generating the second frame by interpolation is 3 ms, and the sleeping of the thread and the power-gating of the graphic processing unit 150 may be sustained for 2 ms (for example V1−V2=2) to delay the second frame. It should be noted that the time length listed above are only used for illustration purpose.

It can be appreciated from the above description for Steps S01-S04 that, when the present embodiment processes the request for a plurality of frames, it may employ another method to generate a specific ratio of frames from all the frames. For example, the present embodiment processed three frames, and one of them is a frame generated by interpolation, so as to achieve the effects of saving the processing time and power for the graphic processing unit 150.

### Second Embodiment

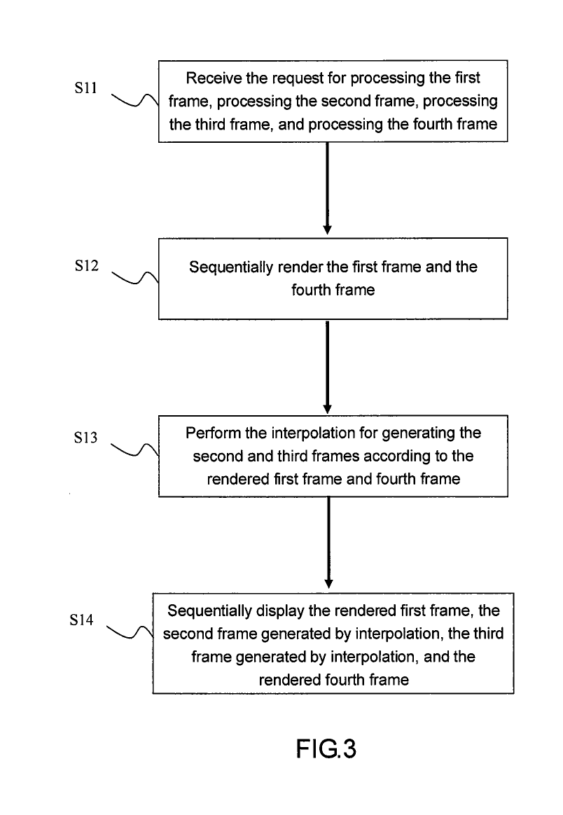

FIG. 3 illustrates a method for driving the graphic processing unit 150 of another embodiment according to the present invention. The method may be applied in the computer system 100 shown in FIG. 1. In particular, the method may be executed by the central processing unit 110 in cooperation with the graphic processing unit 150. In short, the method shown in FIG. 3 may employ two rendered frames for interpolation to generate a plurality of frames, and the display sequence of the frames generated by interpolation may be between the displaying of the two rendered frames as further described below.

The following description should be referred in connection with FIG. 1 and FIG. 3.

Step S11: In order to sequentially display the first frame, the second frame, the third frame and the fourth frame, the application program sent the request for processing the first, second, third and fourth frames, and the central processing unit 110 receives the request for processing the first, second, third and fourth frames.

Step S12: The graphic processing unit 150 sequentially renders the first frame and the fourth frame. The central processing unit 110 controls the graphic processing unit 150 to firstly render the first frame, and then render the fourth frame according to the request for processing the first frame and processing the fourth frame. The information required for rendering a frame includes: the geometry information, the viewpoint information, the texture information, the lighting information, the shading information, or a combination of the information listed above. In response to the request for processing the first, second, third and fourth frames in Step S12, the graphic processing unit 150 is controlled to only render the first and fourth frames, but ignore the rendering of the second and third frames. Because the frame rendering by the graphic processing unit 150 may consume more processing time and power, the present embodiment employs another alternative method to generate the second and third frames to achieve the effects of saving processing time and power.

Moreover, Step S12 further employs the central processing unit 110 or the graphic processing unit 150 to measure the time required for frame rendering, such as measuring the time required for rendering the first frame as a duration V1, measuring the time required for rendering the fourth frame as a duration V4. The durations V1 and V4 are further described in the following context.

Step S13: The central processing unit 110 controls the graphic processing unit 150 to perform the interpolation to generate the second and third frames according to the rendered first frame and fourth frame. For example, the interpolation may be a linear interpolation or a non-linear interpolation. Step S13 may also employ the central processing unit 110 or the graphic processing unit 150 to respectively measure the durations V2 and V3 for interpolation of the second and third frames. The durations V2 and V3 are further described in the following context.

Step S14: The method sequentially displays the rendered first frame, the second frame generated by interpolation, the third frame generated by interpolation, and the rendered fourth frame. The central processing unit 110 controls the graphic processing unit 150 to sequentially display the rendered first frame, the second frame generated by interpolation, the third frame generated by interpolation, and the rendered fourth frame. Preferably, the rendered first frame is displayed right after the fourth frame is rendered. It should be noted that the first, second, third and fourth frames are configured by the application program to be sequential.

The present embodiment does not actually render the second and third frames. Generally, the second and third frames generated by interpolation may require less time than rendering of the second and third frames, so that it may usually save the processing time and power for the graphic processing unit 150.

Similarly, in order to avoid the micro stuttering perceived by the user while viewing the first, second, third and fourth frames, after generation of the second and third frames, the time difference between the duration V1 or duration V4 and the duration V2 or duration V3 (for example V1−V2, V1−V3, V4−V2 or V4−V3) may be used to sleep the thread and accordingly power-gate the graphic processing unit 150 for the second and third frames, such that the frame rates become less inconsistent. Because Step S04 already has the detailed description in the previous context, the description is not repeated here.

It can be known from the description of Steps S11-S14, the present embodiment may interpolate with multiple frames (not only limited to two frames), so as to further achieve the effects of saving the processing time and power for the graphic processing unit 150.

### Third Embodiment

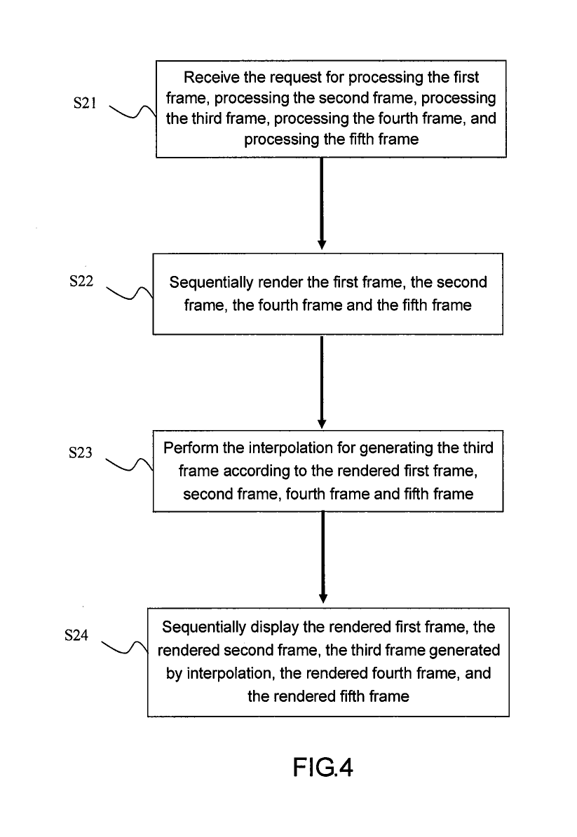

FIG. 4 illustrates a method for driving the graphic processing unit 150 of another embodiment according to the present invention. The method shown in FIG. 4 may employ the interpolation of multiple frames to generate one frame (but the present invention is not limited to this), and the display sequence of the frames generated by interpolation may be between the displaying of the multiple frames as further described below.

The following description should be referred in connection with FIG. 1 and FIG. 4.

Step S21: In order to sequentially display the first frame, the second frame, the third frame, the fourth frame and the fifth frame, the application program sent the request for processing the first, second, third, fourth and fifth frames, and the central processing unit 110 receives the request for processing the first, second, third, fourth and fifth frames.

Step S22: The graphic processing unit 150 sequentially renders the first frame, the second frame, the fourth frame and the fifth frame. The central processing unit 110 controls the graphic processing unit 150 to sequentially render the first frame, the second frame, the fourth frame and the fifth frame according to the request for processing the first, second, fourth and fifth frames. The information required for rendering a frame includes: the geometry information, the viewpoint information, the texture information, the lighting information, the shading information, or a combination of the information listed above.

Moreover, Step S22 further employs the central processing time 110 or the graphic processing unit 150 to measure the time required for frame rendering, such as respectively measuring the time required for rendering the first, second, fourth and fifth frames as durations V1, V2, V4 and V5.

Step S23: The central processing unit 110 controls the graphic processing unit 150 to perform the interpolation to generate the third frame according to the rendered first, second, fourth and fifth frames. For example, the interpolation may be a linear interpolation or a non-linear interpolation. Step S23 may also employ the central processing unit 110 or the graphic processing unit 150 to respectively measure the duration V3 for interpolation of the third frame.

Step S24: The method sequentially displays the rendered first frame, the rendered second frame, the third frame generated by interpolation, the rendered fourth frame and the rendered fifth frame. The central processing unit 110 controls the graphic processing unit 150 to sequentially display the rendered first frame, the rendered second frame, the third frame generated by interpolation, the rendered fourth frame and the rendered fifth frame. Preferably, the rendered first frame is displayed right after the fifth frame is rendered. Similarly, the first, second, third, fourth and fifth frames are configured by the application program to be sequential.

It should be noted that the present embodiment does not actually render the third frame. The present invention employs the interpolation of multiple frames to generate one frame, so as to enhance the accuracy of interpolation for frame generation (due to more reference samples), and further save the processing time and power for the graphic processing unit 150.

In order to avoid the micro stuttering perceived by the user while viewing the first, second, third, fourth and fifth frames, after generation of the third frame, the difference between any one of the durations V1, V2, V4, V5 and the duration V3 (for example V1−V3, V2−V3, V4−V3 or V5−V3) may be used to sleep the thread and accordingly power-gate the graphic processing unit 150 for the third frame, such that the frame rates become less inconsistent.

It can be known from the above description that when the embodiment according to the present invention is processing the request for a plurality of frames, it may employ another method to generate a specific ratio of frames from all the frames, for example, using linear interpolation or non-linear interpolation for frame generation, and the remaining frames are generated by rendering. The embodiments in the previous context has disclosed a method for generating one or more frames between two frames by interpolation according to the two frames; and, a method for generating a frame (the present invention is not limited to one frame) among a plurality of frames by interpolation according to the plurality of frames (for example two frames in earlier sequence and two frames in later sequence). Compared to the frame rendering, the frames generated by other methods according to the present invention may only require less processing time and power consumption.

The foregoing preferred embodiments are provided to illustrate and disclose the technical features of the present invention, and are not intended to be restrictive of the scope of the present invention. Hence, all equivalent variations or modifications made to the foregoing embodiments without departing from the spirit embodied in the disclosure of the present invention should fall within the scope of the present invention as set forth in the appended claims.

1. A method for driving a graphic processing unit (GPU), comprising:
receiving a request for processing a first frame, a second frame, and a third frame;
controlling the GPU to render the first frame and the third frame according to the request;
controlling the GPU to perform an interpolation for generating the second frame according to the rendered first frame and the rendered third frame; and
controlling the GPU to display the rendered first frame, the second frame generated by interpolation, and the rendered third frame.

2. The method of claim 1, wherein the first frame, the second frame, and the third frame are sequential frames.

3. The method of claim 1, wherein the first frame is displayed right after the third frame is rendered.

4. The method of claim 1, wherein generating the second frame consumes less time than rendering the first frame or rendering the third frame.

5. The method of claim 4, further comprising power-gating the GPU based on the difference between an amount of time the GPU takes to render the first frame and an amount of time the GPU takes to generate the second frame.

6. The method of claim 4, further comprising power-gating the GPU based on the difference between an amount of time the GPU takes to render the third frame and an amount of time the GPU takes to generate the second frame.

7. The method of claim 1, further comprising:
receiving a request for processing a fourth frame;
controlling the GPU to perform an interpolation for generation of the fourth frame based on the first frame and the third frame; and
controlling the GPY to display the fourth frame generated by interpolation after displaying the second frame generated by interpolation and before displaying of the rendered third frame.

8. The method of claim 1, further comprising:
receiving a request for processing a fourth frame and a fifth frame;
controlling the GPU to render the fourth frame and the fifth frame according to the request for processing the fourth frame and the fifth frame;
controlling the GPU to perform an interpolation for generation of the second frame according to the fifth frame, the first frame, the third frame and the fourth frame; and
controlling the GPU to sequentially display the rendered fifth frame, the rendered first frame, the second frame generated by interpolation, the rendered third frame and the rendered fourth frame.

9. The method of claim 1, wherein controlling the GPU to render the first frame and the third frame further comprises controlling the GPU to render one or more of geometry information, viewpoint information, texture information, lighting information, shading information.

10. A computer-readable medium storing instructions, that when executed by a processor, cause a computer system to drive a graphic processing unit (GPU), by performing the steps of:
receiving a request for processing a first frame, a second frame, and a third frame;
controlling the GPU to render the first frame and the third frame according to the request;
controlling the GPU to perform an interpolation for generating the second frame according to the rendered first frame and the rendered third frame; and
controlling the GPU to display the rendered first frame, the second frame generated by interpolation, and the rendered third frame.

11. The computer-readable medium of claim 10, wherein the first frame, the second frame, and the third frame are sequential frames.

12. The computer-readable medium of claim 10, wherein the first frame is displayed right after the third frame is rendered.

13. The computer-readable medium of claim 10, wherein generating the second frame consumes less time than rendering the first frame or rendering the third frame.

14. The computer-readable medium of claim 13, further comprising power-gating the GPU based on the difference between an amount of time the GPU takes to render the first frame and an amount of time the GPU takes to generate the second frame.

15. The computer-readable medium of claim 13, further comprising power-gating the GPU based on the difference between an amount of time the GPU takes to render the third frame and an amount of time the GPU takes to generate the second frame.

16. The computer-readable medium of claim 10, further comprising:
receiving a request for processing a fourth frame;
controlling the GPU to perform an interpolation for generation of the fourth frame based on the first frame and the third frame; and
controlling the GPY to display the fourth frame generated by interpolation after displaying the second frame generated by interpolation and before displaying of the rendered third frame.

17. The computer-readable medium of claim 10, further comprising:
receiving a request for processing a fourth frame and a fifth frame;
controlling the GPU to render the fourth frame and the fifth frame according to the request for processing the fourth frame and the fifth frame;
controlling the GPU to perform an interpolation for generation of the second frame according to the fifth frame, the first frame, the third frame and the fourth frame; and
controlling the GPU to sequentially display the rendered fifth frame, the rendered first frame, the second frame generated by interpolation, the rendered third frame and the rendered fourth frame.

18. The computer-readable medium of claim 10, wherein controlling the GPU to render the first frame and the third frame further comprises controlling the GPU to render one or more of geometry information, viewpoint information, texture information, lighting information, shading information.

19. A computing device for driving a graphic processing unit (GPU), the computing device comprising:
a graphics processing unit;
a processor coupled to the graphics processing unit; and
a memory coupled to the processor, wherein the memory includes a program having instructions that, when executed by the processor, cause the processor to:
receive a request for processing a first frame, a second frame, and a third frame;
control the GPU to render the first frame and the third frame according to the request;
control the GPU to perform an interpolation for generating the second frame according to the rendered first frame and the rendered third frame; and
control the GPU to display the rendered first frame, the second frame generated by interpolation, and the rendered third frame.

20. The computing device of claim 19, the memory further including instructions that, when executed by the processor, cause the processor to:
receive a request for processing a fourth frame;
control the GPU to perform an interpolation for generation of the fourth frame based on the first frame and the third frame; and
control the GPY to display the fourth frame generated by interpolation after displaying the second frame generated by interpolation and before displaying of the rendered third frame.
